(19) United States
(12) Patent Application Publication
(10) Pub. No.: US 2010/0237011 A1
(43) Pub. Date: Sep. 23, 2010

(54) BLOOD TREATMENT SYSTEMS AND RELATED METHODS

(76) Inventors: Edward Allan Ross, Gainesville, FL (US); Thomas Irvin Folden, Alamo, CA (US); David A. Gavin, Clayton, CA (US)

Correspondence Address: FISH & RICHARDSON P.C., P.O. BOX 1022, MINNEAPOLIS, MN, 55440-1022, US

(21) Appl. No.: 12/408,353

(22) Filed: Mar. 20, 2009

(51) Int. Cl. B01D 29/60; B01D 29/66; B01D 65/02

(52) U.S. Cl. 210/636; 210/108; 210/98

(57) ABSTRACT

This disclosure relates to blood treatment systems and related methods. The systems can include a blood pump arranged to move blood through a blood filter, a pressure sensor arranged to measure pressure of blood flowing through a fluid line between the blood pump and the blood filter, and a controller configured to activate a rinse pump to move rinse fluid through the blood filter based at least in part on the pressure of blood flowing through the fluid line as measured by the pressure sensor.

### TECHNICAL FIELD

This disclosure relates to blood treatment systems and related methods.

### BACKGROUND

During some medical procedures, toxic substances and/or waste are removed from a patient's bloodstream through processing carried out in an extracorporeal circuit. Contact between blood and the surfaces of the extracorporeal circuit can result in the formation of clots. Clots in the extracorporeal circuit can form deposits on filter walls and, thus, impair the removal of toxic substances and/or waste from the blood. In order to reduce the likelihood of clots forming in the extracorporeal circuit, an anticoagulant, such as heparin, is typically introduced into the blood flowing through the extracorporeal circuit.

### SUMMARY

In one aspect of the invention, a blood treatment system includes a first fluid line capable of being placed in fluid communication with blood of a patient, a blood filter in fluid communication with the first fluid line, a blood pump arranged to move blood through at least a portion of the first fluid line and the blood filter when the first fluid line is in fluid communication with the blood of the patient, a rinse pump arranged to move rinse fluid through the blood filter, a first pressure sensor arranged to measure pressure of fluid flowing through a portion of the first fluid line between the blood pump and the blood filter, and a controller in communication with the first pressure sensor and the rinse pump. The controller is configured to activate the rinse pump to move rinse fluid through the blood filter based at least in part on the pressure of blood flowing through the first fluid line as measured by the first pressure sensor.

In another aspect of the invention, a blood treatment method includes moving blood through a blood filter and through a portion of a fluid line positioned between the blood filter and a blood pump, sensing a first pressure of blood in the fluid line between the blood filter and the blood pump, and moving rinse fluid through the blood filter based at least in part on the sensed first pressure.

In an additional aspect of the invention, a computer-implemented method includes activating a blood pump to move blood through a blood filter and through a portion of a fluid line positioned between the blood filter and a blood pump, receiving a sensed first pressure of blood in the fluid line between the blood filter and the blood pump, and activating a rinse pump to move rinse fluid through the blood filter based at least in part on the sensed first pressure.

Implementations can include one or more of the following features.

In some implementations, the controller is in communication with the blood pump and is configured to deactivate the blood pump based at least in part on the pressure of blood flowing through the first fluid line as measured by the first pressure sensor.

In some implementations, the rinse pump is in fluid communication with a second fluid line, the second fluid line is in communication with the first fluid line, and the rinse pump is arranged to move rinse fluid through the second fluid line to the first fluid line.

In some implementations, the second fluid line is in fluid communication with a receptacle containing rinse fluid, and the rinse pump is arranged to move rinse fluid from the receptacle into the second fluid line.

In some implementations, the controller is configured to deactivate the rinse pump after a period of operation of the rinse pump.

In some implementations, the controller is configured to activate the blood pump after the period of operation of the rinse pump.

In some implementations, the controller is configured to deactivate the rinse pump based at least in part on the pressure of rinse fluid moving through the first fluid line as measured by the first pressure sensor.

In some implementations, the controller is configured to activate the blood pump based at least in part on the pressure of the rinse fluid moving through the first fluid line as measured by the first pressure sensor.

In some implementations, the blood treatment system further includes a second pressure sensor arranged to measure pressure of fluid flowing downstream of the blood filter. The controller is in communication with the second pressure sensor, and the controller is configured to activate the rinse pump to move rinse fluid through the blood filter based at least in part on the pressure of blood flowing downstream of the blood filter as measured by the second pressure sensor.

In some implementations, the controller is in communication with the blood pump and is configured to deactivate the blood pump based at least in part on the pressure of blood flowing downstream of the filter as measured by the second pressure sensor.

In some implementations, the controller is configured to activate the rinse pump to move rinse fluid through the blood filter when the difference in the pressure of the blood measured by the first pressure sensor and the pressure of the blood measured by the second pressure sensor exceeds a limit (e.g., about five percent or more above a target value).

In some implementations, the controller is configured to deactivate the blood pump when the difference in the pressure of the blood measured by the first pressure sensor and the pressure of the blood measured by the second pressure sensor exceeds the limit.

In some implementations, the controller is configured to activate the rinse pump to move rinse fluid through the blood filter when the pressure of the blood measured by the first pressure sensor exceeds a target value by about five percent of the target value or more.

In some implementations, the controller is configured to deactivate the blood pump when the pressure of the blood measured by the first pressure sensor exceeds the target value by about five percent of the target value or more.

In some implementations, the controller is configured to activate the rinse pump to move rinse fluid through the blood filter when the pressure of the blood measured by the first pressure sensor is above a limit for at least five seconds.

In some implementations, the controller is configured to deactivate the blood pump when the pressure of the blood measured by the first pressure sensor is above the limit for at least five seconds.

In some implementations, the controller is configured to determine a flow rate of the rinse fluid.

In some implementations, the controller is configured to determine the flow rate of the rinse fluid based on a pump speed of the rinse pump.

In some implementations, the controller is configured to set an ultrafiltration rate based on the determined flow rate of the rinse fluid.

In some implementations, the controller is configured to increase an ultrafiltration rate by an amount that is approximately equal to the determined flow rate of the rinse fluid.

In some implementations, the blood treatment system further includes a hemodiafiltration filter in fluid communication with the blood filter. The hemodiafiltration filter is capable of converting dialysis fluid into rinse fluid.

In some implementations, the blood filter is a dialyzer.

In some implementations, the blood treatment system is a hemodialysis system.

In some implementations, the blood treatment method further includes stopping movement of blood through the blood filter based at least in part on the sensed first pressure of the blood.

In some implementations, the blood treatment method further includes sensing a second pressure of blood flowing downstream of the blood filter.

In some implementations, the rinse fluid is moved through the blood filter based on the sensed first and second pressures.

In some implementations, the rinse fluid is moved through the blood filter if the difference between the sensed first pressure and the sensed second pressure is above a limit.

In some implementations, the blood treatment method further includes stopping movement of blood through the blood filter if the difference between the sensed first pressure and the sensed second pressure is above the limit.

In some implementations, the blood treatment method further includes stopping movement of rinse fluid through the blood filter after a period of time.

In some implementations, the blood treatment method further includes moving blood through the blood filter after the period of time.

In some implementations, the blood treatment method further includes sensing the pressure of rinse fluid in the fluid line between the blood filter and the blood pump, and stopping movement of rinse fluid through the blood filter based at least in part on the sensed pressure of the rinse fluid.

In some implementations, the blood treatment method further includes moving blood through the blood filter based at least in part on the sensed pressure of the rinse fluid.

In some implementations, the blood treatment method further includes deactivating the rinse pump upon determining that a volume of rinse fluid moved through the blood filter is greater than or equal to a threshold volume (e.g., about 50 mL to about 500 mL).

In some implementations, the blood treatment method further includes determining a flow rate of the rinse fluid.

In some implementations, the blood treatment method further includes performing ultrafiltration at an ultrafiltration rate based on the determined flow rate of the rinse fluid.

In some implementations, the blood treatment method further includes converting dialysis fluid into rinse fluid.

In some implementations, the blood treatment method is a hemodialysis method.

In some implementations, the computer-implemented method further includes deactivating the blood pump based at least in part on the sensed first pressure.

In some implementations, the computer-implemented method further includes determining a flow rate of rinse fluid moved through the blood filter based at least in part on an operating speed of the rinse pump.

In some implementations, the computer-implemented method further includes increasing an ultrafiltration rate by an amount that is about equal to the flow rate of the rinse fluid.

In some implementations, the computer-implemented method further includes deactivating the rinse pump upon determining that a volume of rinse fluid moved through the blood filter is greater than or equal to a threshold volume (e.g., about 50 mL to about 500 mL).

In some implementations, the computer-implemented method further includes receiving a sensed pressure of rinse fluid in the fluid line between the blood filter and the blood pump, and deactivating the rinse pump based at least in part on the sensed pressure of the rinse fluid.

In some implementations, the computer-implemented method further includes activating a hemodiafiltration pump to convert dialysis fluid to rinse fluid.

In some implementations, the computer-implemented method further includes receiving a sensed second pressure of blood flowing downstream of the blood filter.

In some implementations, the rinse pump is activated if the difference between the sensed first pressure and the sensed second pressure is above a limit.

Implementations can include one or more of the following advantages.

In some implementations, the blood treatment system includes a controller configured to stop a blood pump and start a rinse pump to flow rinse fluid through a blood filter based at least in part on a pressure measured upstream of the blood filter. A high pressure upstream of the blood filter is indicative of deposit buildup on the blood filter. Accordingly, by forcing rinse fluid through the blood filter based on a high pressure reading measured upstream of the blood filter, the controller forces rinse fluid through the blood filter when deposits begin building up on the blood filter. By delivering rinse fluid as needed to remove deposits from the filter, the blood treatment system can reduce the need to use an anticoagulant, such as heparin, during the medical treatment. As such, this rinse procedure does not detrimentally affect the clotting ability of blood. Furthermore, this rinse procedure can reduce the likelihood of side effects that can result from anticoagulants, such as heparin.

Additionally or alternatively, as compared to blood treatment systems that deliver rinse fluid through a blood filter at regular time intervals, the selective delivery of rinse fluid through the blood filter based on a measured pressure of the blood can allow the rinse fluid to be used more efficiently during a medical procedure. Such improved efficiency in the use of the rinse fluid can result in cost savings and, in some cases, decreased procedure times.

In some implementations, the blood treatment system includes a hemodiafiltration filter to produce rinse fluid from dialysate on demand for rinsing the filter. The production of rinse fluid from dialysate can reduce the need to provide a separate supply of manufactured rinse fluid during the medical treatment, which can reduce cost of the medical procedure. Reducing the need to provide a separate supply of manufactured rinse fluid can also reduce the likelihood of operator errors associated with replacement of the supply of manufactured rinse fluid.

Other aspects, features, and advantages will be apparent from the description and drawings, and from the claims.

### DESCRIPTION OF DRAWINGS

FIG. 1 is a schematic view of a blood treatment system with a filter pressure sensor disposed in an arterial line between a blood pump and a dialyzer. The blood treatment system is connected to a patient.

FIG. 2 is a schematic view of inputs to and outputs from a controller of the blood treatment system of FIG. 1.

FIG. 3 is a flowchart of a process used to control operation of the blood pump and rinse pump of the blood treatment system of FIG. 1 based on the pressure measurements received from the filter pressure sensor and a venous pressure sensor.

FIG. 4 is a schematic view of a blood treatment system including a hemodiafiltration system in fluid communication with a rinse system to provide rinse fluid to a dialyzer. The blood treatment system is connected to a patient.

FIG. 5 is a schematic view of inputs to and outputs from a controller of the blood treatment system of FIG. 4.

### DETAILED DESCRIPTION

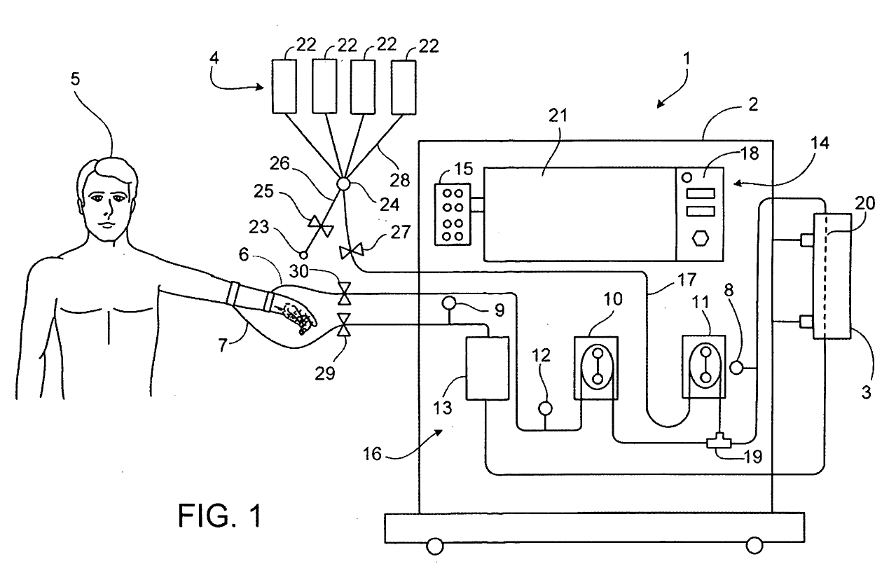

Referring to FIG. 1, an extracorporeal blood treatment system 1 includes a dialyzer 3 in fluid communication with a dialysis machine 2. A rinse supply system 4 is also in fluid communication with the dialysis machine 2. During use (e.g., during a hemodialysis treatment), a patient 5 is connected to the blood treatment system 1, and blood is pumped from the patient 5 to the dialyzer 3, where toxic substances and/or waste is/are removed from the blood. The dialysis machine 2 controls the flow of blood from the patient 5 to the dialyzer 3 and controls the return of blood to the patient 5 from the dialyzer 3. As discussed below, the dialysis machine 2 includes a filter pressure sensor 8 positioned upstream of the dialyzer 3 and a venous pressure sensor 9 positioned downstream of the dialyzer 3. The dialysis machine 2 monitors the difference in the pressure measured at the filter pressure sensor 8 and the pressure measured at the venous pressure sensor 9. This difference is sometimes referred to herein as “pressure drop.” Based at least in part on a measured increase in the pressure drop across the dialyzer 3, the dialysis machine 2 further controls the flow of biocompatible rinse fluid (e.g., saline solution) from the rinse supply system 4 to the dialyzer 3 to remove at least some of the deposits (e.g., clots) that can build up on the dialyzer 3 during blood treatment. As discussed below, a substantially equivalent volume of rinse fluid can be removed from the extracorporeal blood treatment system 1 (e.g., over a period of time based on the filtration rate of the dialyzer 3) prior to the end of the procedure and/or prior to a subsequent rinse cycle.

The dialyzer 3 includes a semi-permeable membrane 20 that is substantially impermeable to blood cells and proteins is substantially permeable to smaller molecules, such as water and those of toxic substances and/or waste products that can be found in blood. During use, blood flows on one side of the semi-permeable membrane and treatment solution flows on the other side of the membrane such that toxic substances and/or waste products moving through the semipermeable membrane are carried away by the treatment solution. In some implementations, the dialyzer 3 is releasably attached to the dialysis machine 2 such that the dialyzer 3 can be cleaned and/or replaced between uses of the blood treatment system 1.

The rinse supply system 4 includes a connector 24, bags 22, supply lines 28, a priming line 26, a priming connector 23, and a priming clamp 25. Each bag 22 contains a volume of rinse fluid. Supply lines 28 provide fluid communication between each respective bag 22 and the connector 24. The connector 24 can be placed in fluid communication with a rinse line 17 of the dialysis machine 2, as shown in FIG. 1. The dialysis machine 2 can control the flow of rinse fluid from the rinse supply system 4 to the dialyzer 3. The volume of rinse fluid that can be delivered from the rinse supply system 4 toward the dialyzer 3 can be about 50 mL or greater and/or about 500 mL or less.

The priming line 26 extends from the connector 24. A priming connector 23 is disposed near an end of the priming line 26. The priming connector 23 can be used to connect the priming line 26 to an arterial line 6 of the dialysis machine 2 during a priming procedure. A priming clamp 25 is disposed along the priming line 26, between the connector 24 and the priming connector 23. The priming clamp 25 can control the flow of fluid through the priming line 26.

The bags 22 can be sterile and can contain substantially equal volumes of rinse fluid. The bags 22 can be positioned (e.g., hung) in place above the dialysis machine 2 such that rinse fluid can flow toward the dialyzer 3 under the force of gravity. This positioning of the bags 22 can, for example, reduce the amount of power required to move the rinse fluid from the rinse supply system 4 to the dialyzer 3. Positioning the bags 22 above the dialysis machine 2 can also facilitate movement of air bubbles toward the rinse supply system 4 and away from the dialyzer 3.

The dialysis machine 2 includes a user interface 14, a fluid handling section 16, and a controller 15 in communication with the user interface 14 and with the fluid handling section 16. As described below, the controller 15 can control the flow of fluid through the fluid handling section 16 based at least in part on user-defined parameters received by the controller 15 from the user interface 14.

The user interface 14 includes an input device 18 and a display 21 in communication with the input device 18. The input device 18 can be, for example, a keyboard and/or buttons to allow a user to enter parameters related to the operation of the fluid handling section 16. For example, using the input device 18, the user can input, among other things, the volume of rinse fluid to be used to rinse the dialyzer 3. The display 21 can display parameters associated with the setup, progress, and shutdown of the blood treatment system 1. For example, the display 21 can display the parameters entered by the user through the input device 18. Additionally or alternatively, the display 21 can provide an alert related to detection of an increased pressure drop measured across the dialyzer 3.

The fluid handling section 16 of the dialysis machine 2 includes the arterial line 6, the rinse line 17, a venous line 7, a blood pump 10, and a rinse pump 11. The arterial line 6, the rinse line 17, and the venous line 7 are each in fluid communication with the dialyzer 3. The arterial line 6 and the rinse line 17 are each positioned upstream of the dialyzer 3, and the venous line 7 is positioned downstream of the dialyzer 3. The rinse line 17 is connected to the arterial line 6 via a T-connector 19 such that the rinse line 17 is in fluid communication with the arterial line 6, upstream of the dialyzer 3. Other types of connectors, such as Y-connectors, can alternatively be used to place the rinse line 17 in fluid communication with the arterial line 6.

The blood pump 10 is in fluid communication with the arterial line 6 to move blood from the patient 5 along the arterial line 6 and through the dialyzer 3. The rinse pump 11 is in communication with the rinse line 17 such that rinse fluid can flow from the rinse supply system 4, through a portion of the arterial line 6, and through the dialyzer 3. Fluid (e.g., blood, rinse fluid, or a combination) exiting the dialyzer 3 moves along the venous line 7 from the dialyzer 3 toward the patient 5.

The blood pump 10 and the rinse pump I 1 are peristaltic pumps operable to provide substantially constant volumetric flow rates through the arterial line 6 and the rinse line 17, respectively. For example, the blood pump 10 and the rinse pump 11 can each provide substantially constant volumetric flow rates of greater than about 10 ml/min and/or less than about 1000 ml/min (e.g. about 100 ml/min to about 600 ml/min).

To facilitate movement of fluid through the arterial line 6 and the rinse line 17 under the force of these peristaltic pumps, at least a portion of each of the arterial line 6 and the rinse line 17 can be flexible tubing made of materials such as polyvinylchloride (PVC) or silicone rubber. In some implementations, at least a portion of the venous line 7 is flexible tubing of at least one of these materials. In certain implementations, the arterial line 6, the rinse line 17, and the venous line 7 are replaceable between uses. For example, the arterial line 6 and the venous line 7 can be provided as part of a disposable line set that is discarded after a single use.

The filter pressure sensor 8 is located along the arterial line 6, downstream of the blood pump 10, and an arterial pressure sensor 12 is located along the arterial line 6, upstream of the blood pump 10. The filter pressure sensor 8 is disposed along the arterial line 6 to measure the pressure of fluid in the arterial line 6 upstream of the dialyzer 3 and downstream of the T-connector 19. The arterial pressure sensor 12 is positioned upstream of the blood pump 10 to measure the arterial pressure of the patient 5. An arterial clamp 30 is upstream of the arterial pressure sensor 12 such that the arterial clamp 30 can restrict (e.g., stop) the flow of fluid flowing along the arterial line 6 from the patient 5 toward the blood pump 10. For example, the arterial clamp 30 can stop the flow of fluid flowing from the patient 5 along the arterial line 6.

The venous pressure sensor 9, an air detector 13, and a venous clamp 29 are positioned along the venous line 7, each downstream of the dialyzer 3. The venous pressure sensor 9 is disposed along the venous line 7 to measure the pressure of the fluid in the venous line at a point upstream of the venous clamp 29 and downstream of the air detector 13. The air detector 13 can detect the presence of air in the fluid returning to the patient 5. In some implementations, the venous clamp 29 is in communication with the air detector 13 (e.g., through the controller 15) such that detection of air at the air detector 13 results in closing the venous clamp 29 to reduce the likelihood of air entering the bloodstream of the patient 5.

The filter pressure sensor 8 and the venous pressure sensor 9 can each be a standard strain gauge pressure transducer manufactured by Honeywell International, Inc. of Morristown, N.J. Additionally or alternatively, other types of pressure sensors can be used.

The rinse line 17 includes a rinse clamp 27 downstream from the rinse supply system 4. The rinse clamp 27 is controlled (e.g., through communication with the controller 15) between an open and closed position during priming of the blood treatment system 1. During the medical procedure, the rinse clamp 27 is normally open to allow rinse fluid to move from the rinse system 4 toward the rinse pump 11.

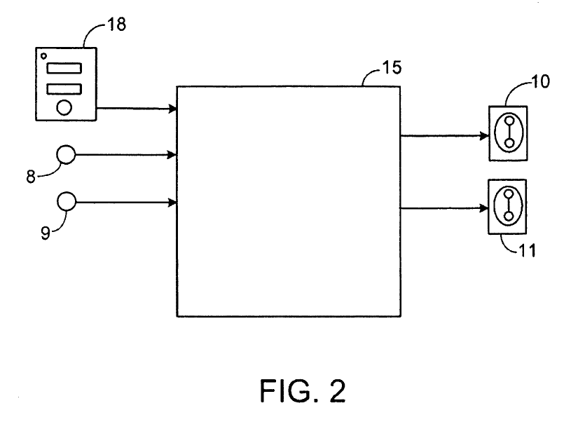

Referring to FIG. 2, the controller 15 is electrically connected to the filter pressure sensor 8, the venous pressure sensor 9, the blood pump 10, the rinse pump 11, and the input device 18. During use, the controller 15 receives input signals from the input device 18, the filter pressure sensor 8, and the venous pressure sensor 9. The controller 15 provides an output signal to the blood pump 10 and an output signal to the rinse pump 11 to control the flow of rinse fluid through the dialyzer 3. The controller 15 controls the activation of the blood pump 10 and the rinse pump 11 based on the signals from the filter pressure sensor 8 and the venous pressure sensor 9. Additionally or alternatively, the controller 15 can control the activation of the blood pump 10 and the rinse pump 11 based on the signal from the input device 18.

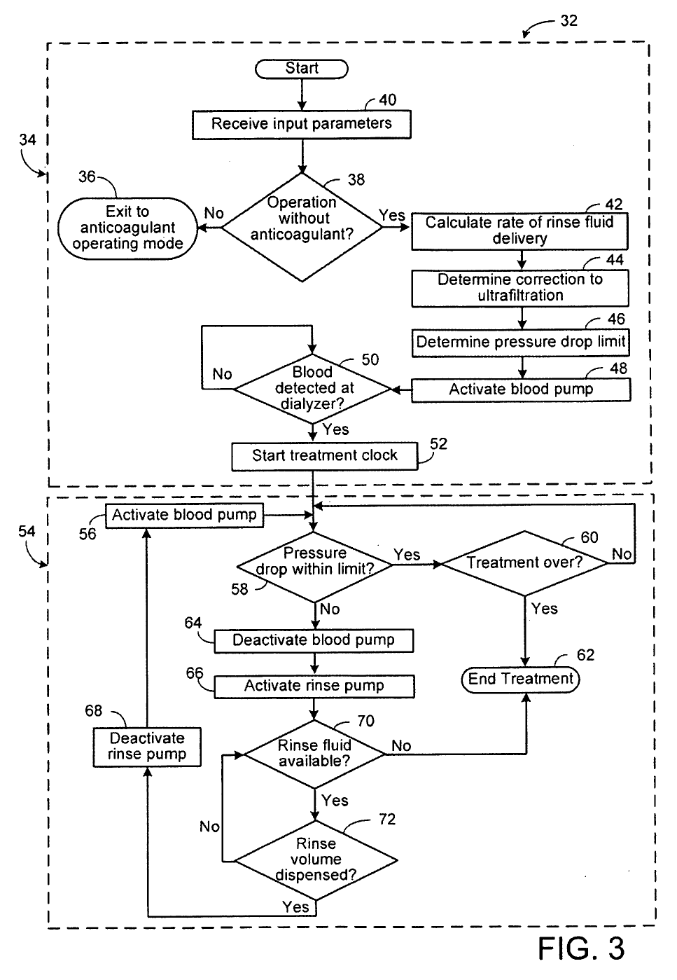

FIG. 3 shows an example of a controller process 32 used to control the operation of the blood pump 10 and the rinse pump 11 based on the pressure measurements received from the filter pressure sensor 8 and the venous pressure sensor 9. The controller process 32 includes an initialization stage 34 and a monitoring stage 54.

In the initialization stage 34, the controller 15 receives 40 input parameters (e.g., through input device 18) related to the medical treatment. The input parameters include, among other things, an indication of whether the medical treatment will be performed without an anticoagulant (e.g., heparin-free). The input parameters also include the duration of each flush cycle and the volume of rinse fluid (e.g. about 200 mL or greater and/or about 250 mL or less) to be delivered through the dialyzer 3 during each flush cycle. The input parameters further include the treatment time for the medical procedure. In some implementations, the input parameters include a pressure drop limit across the dialyzer 3 above which the controller 15 deactivates the blood pump 10 and activates the rinse pump 11. The pressure drop limit can be a percentage change relative to the normal pressure drop across the dialyzer 3. In some implementations, the percentage change is about 5 percent or greater and/or about 30 percent or less (e.g., about 10 percent to about 20 percent). Pressure drop changes in this percentage range can facilitate early detection of deposit buildup on the dialyzer 3, prior to flow degradation that can result in an alarm condition. For example, a change in pressure drop across the filter can be detected and a rinse procedure can be started before the pressure in the arterial line increases to a level that activates an alarm and/or shutdown procedure.

If the controller 15 determines 38 that the treatment is to be performed with an anticoagulant, the initialization stage 34 exits 36 to an anticoagulant operating mode. If the controller 15 determines 38 that the medical treatment is to be performed without an anticoagulant, the controller 15 calculates 42 the rate of rinse fluid delivery (e.g., the ratio of the volume of rinse fluid to be delivered per flush cycle to the duration of each flush cycle). The controller 15 determines 44 a correction to the ultrafiltration rate by adding the rate of rinse fluid delivery to the ultrafiltration rate prescribed for the medical procedure. For example, if the prescribed ultrafiltration rate is 1500 ml/hr and 250 ml of rinse fluid is to be delivered through the dialyzer 3 over a flush cycle of 15 minutes, the ultrafiltration rate of 1500 ml/hr would be corrected to 2500 ml/hr. The ultrafiltration rate stays at the corrected rate based on the periodicity of the flush and the amount of rinse fluid used to rinse the dialyzer 3. In the above example 250 ml is flushed every 15 minutes such that a 1000 ml/hr increase in fluid can be removed from the blood treatment system 1. The ultrafiltration rate stays the same until the periodicity of the flush and the amount of rinse fluid are altered again, resulting in the calculation of another UF rate.

The controller 15 determines 46 the pressure drop limit across the dialyzer 3 such that the controller 15 stops the blood pump 10 and starts the rinse pump 11 based on detecting a pressure drop above the limit. In some implementations, this pressure drop limit is determined 46 by adding a percentage change (e.g., as received as an input parameter by the controller 15) to a target pressure drop. The target pressure drop can vary based on the volumetric flow rate through the dialyzer 3. In some implementations, the controller 15 includes a correlation between the target pressure drop and the volumetric flow rate through the dialyzer 3 (e.g., as determined by the operating speed of the blood pump 10). For example, a flow rate of 600 ml/min through the blood pump 10 can correlate to a target pressure drop of 50 mm Hg across the dialyzer 3 while a flow rate of 100 ml/min through the blood pump 10 can correlate to a target pressure drop of 20 mm Hg across the dialyzer 3. In certain implementations, the target pressure drop is determined during the start of the monitoring stage 54 and stored by the controller 15.

After determining the pressure drop limit, the controller 15 activates 48 the blood pump 10 to begin the medical treatment. If blood has been detected 50 at the dialyzer 3, the controller starts 52 the treatment clock and initiates the monitoring stage 54. Optical transmission can be used to sense blood at the dialyzer 3. An optical sensor can, for example, be used to sense a change in optical transmission between water or saline (about 100 percent optical transmission) and blood (about ten percent optical transmission).

The controller 15 compares 58 the pressure drop across the dialyzer 3 to the pressure drop limit determined 46 in the initialization stage 34. If the pressure drop across the dialyzer 3 is within the pressure drop limit, the controller 15 will continue to continuously or periodically compare the pressure drop across the dialyzer 3 with the pressure drop limit until the treatment time has elapsed 60. If the treatment time has elapsed 60, the controller 15 ends 62 the treatment. For example, the controller 15 can end 62 the treatment by stopping the blood pump 10. In addition, the controller 15 can provide an indication of the end of the treatment on the display 21.

If the pressure drop across the dialyzer 3 is not within the pressure drop limit, the controller 15 deactivates 64 the blood pump 10. Deactivation 64 of the blood pump 10 can include sending a warning to the user interface 14 (e.g., to the display 21). In response to the pressure drop exceeding the pressure drop limit, die controller 15 also activates 66 the rinse pump 11 to deliver rinse fluid to the arterial line 6 and through the dialyzer 3. The force of the rinse fluid moving through the dialyzer 3 removes deposit buildup on the dialyzer 3. The controller 15 can deactivate 64 the blood pump 10 if the pressure drop across the dialyzer 3 is not within the pressure drop limit for a period of about one second or longer (e.g., about 5 seconds or longer) and/or about 20 seconds or less (e.g., about ten seconds or less), which can reduce the likelihood that a rinse cycle will be unnecessarily initiated. In certain implementations, the controller 15 is adapted to deactivate 64 the blood pump 10 if the pressure drop across the dialyzer 3 is not within the pressure drop limit for a period of five seconds.

If rinse fluid is not available 70, the controller 15 ends 62 the treatment. In some implementations, the controller 15 can send a warning to the user interface 14 (e.g., the display 15) indicating that that supply of rinse fluid in the rinse system 4 has been depleted. In certain implementations, rinse fluid can be added to the rinse system 4 and the treatment can be resumed.

If the volume of rinse fluid dispensed 72 to the dialyzer 3 is less than the volume of rinse fluid received 40 as an input parameter, the rinse pump 11 continues to move rinse fluid through the dialyzer 3. The controller 15 can estimate the volume of rinse fluid dispensed to the dialyzer 3 based at least in part on the displacement, the operating speed, and the duration of the activity of the rinse pump 1.

If the volume of rinse fluid dispensed 72 to the dialyzer 3 is greater than or equal to the volume of rinse fluid received 40 as an input parameter, the controller 15 deactivates 68 the rinse pump 11. Deactivation 68 of the rinse pump 11 can stop the flow of rinse fluid toward the dialyzer 3. In some implementations, the controller 15 measures the pressure drop across the dialyzer 3 prior to deactivating 68 the rinse pump 11 to determine whether the pressure drop across the dialyzer 3 has returned below the pressure drop limit determined 46 in the initialization stage 34.

After determining that the desired amount of rinse fluid was dispersed to the dialyzer 3, the controller 15 activates 56 the blood pump such that blood flows through the arterial line 6 and through the dialyzer 3. The controller 15 then determines if the pressure drop across the dialyzer 3 is within the pressure drop limit determined 46 in the initialization stage 34. In some implementations, the controller 15 ends the treatment if the pressure drop across the dialyzer 3 has not returned below the pressure drop limit following a flush cycle as this may indicate a significant and/or unremovable blockage in the system 1.

While certain implementations have been described, other implementations are possible.

While the controller process 32 has been described as activating the rinse pump 11 based on the pressure drop across the dialyzer 3, other implementations are possible. For example, in some implementations, the controller 15 also activates the rinse pump 11 to deliver rinse fluid through the dialyzer 3 at routine time intervals (e.g., every 15 minutes). The routine time intervals for delivering rinse fluid through the dialyzer 3 can be input to the controller through an input device at the start of treatment.

While the controller process 32 has been described as detecting deposit buildup on the dialyzer 3 based on the pressure drop measured across the dialyzer 3, other implementations are possible. For example, in some implementations, the controller process includes detecting deposit buildup on the dialyzer 3 based on a change in pressure measured at the filter pressure sensor 8 upstream of the dialyzer 3, at a substantially constant volumetric flow rate of fluid through the arterial line 6. This can reduce the need for an accurate pressure measurement in the venous line 7 downstream of the filter. For example, at a substantially constant volumetric flow rate of fluid through the arterial line 6, a change in pressure measured at the filter pressure sensor 8 over time and/or a change in the pressure with respect to a limit value can indicate deposit buildup on the dialyzer 3. A controller can deactivate a blood pump if the change in pressure measured at the filter pressure sensor 8 is not within a limit for a period of about one second or greater (e.g., about five seconds or greater) and/or about 20 seconds or less (e.g., about ten seconds or less), which can reduce the likelihood that a rinse cycle will be unnecessarily initiated. In certain implementations, the controller is adapted to deactivate the blood pump if the change in pressure measured at the filter pressure sensor 8 is not within a limit for a period of about five seconds.

While the controller process 32 has been described as estimating the volume of rinse fluid passed through the dialyzer 3 based on the displacement, operating speed, and the duration of the activity of the rinse pump, other implementations are possible. In some implementations, the volumetric flow of rinse fluid to the arterial line 6 can be measured directly. For example, a volumetric flow meter can be placed between the pump 11 and the T-connector 19 to measure the volumetric flow rate of rinse fluid entering the arterial line 6. Such direct measurement of the volumetric flow rate of the rinse fluid can, for example, allow for increased accuracy in determining 44 the correct ultrafiltration rate required in response to the addition of rinse fluid to the blood treatment system 1.

While rinse system 4 has been described as receiving rinse fluid contained in bags 22, other implementations are possible. For example, the rinse system 4 can receive rinse fluid from a substantially rigid reservoir.

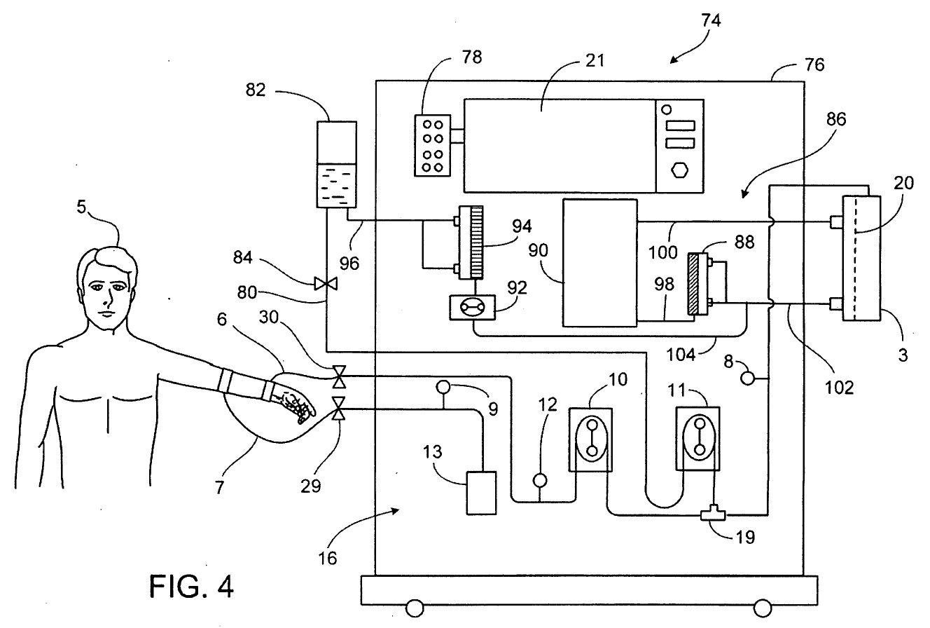

FIG. 4 illustrates another implementation of a blood treatment system 74, which includes an on-line hemodiafiltration system 86. Referring to FIG. 4, the blood treatment system 74 includes a dialyzer 3, a dialysis machine 76, a volumetric balancing unit 90, and the on-line hemodiafiltration system 86. The volumetric balancing unit 90 is in fluid communication with the dialyzer 3 through an intake line 100. The volumetric balancing unit 90 is in fluid communication with the on-line hemodiafiltration system 86 through a dialyzing fluid line 98. The hemodiafiltration system 86 is in fluid communication with a reservoir 82 through a rinse supply line 96.

During use, the derivation of rinse fluid from dialysis fluid can reduce the impact on the patient's fluid balance during a medical treatment. Additionally or alternatively, by allowing dialysate to be converted to rinse fluid, the hemodiafiltration system 86 can reduce the expense associated with the use of manufactured rinse fluids.

The volumetric balancing unit 90 controls pressure of the dialysate flowing through the dialyzer 3 to control the ultrafiltration rate of fluid through the semi-permeable membrane 20 of the dialyzer 3. For example, by reducing the pressure of the dialysate flowing through the dialyzer 3, the volumetric balancing unit 90 can increase the ultrafiltration rate, and by increasing the pressure of the dialysate flowing through the dialyzer 3, the volumetric balancing unit 90 can decrease the ultrafiltration rate.

The hemodiafiltration system 86 includes a dialyzing fluid filter 88, a hemodiafiltration filter 94, a hemodiafiltration pump 92, a dialyzing fluid line 98, a return line 102, a hemodiafiltration line 104, and a rinse supply line 96. The dialyzing fluid filter 88 is in fluid communication with the volumetric balancing unit 90 through the dialyzing fluid line 98. The dialyzing fluid filter 88 is in fluid communication with the dialyzer 3 through the return line 102 such that at least a portion of the dialysate filtered through the dialyzing fluid filter 88 can pass through the dialyzer 3. The return line 102 is in fluid communication with the hemodiafiltration line 104 such that at least a portion of the filtered dialysate moving from the dialyzing fluid filter 88 can move along the hemodiafiltration line 104 to the hemodiafiltration filter 94. The hemodiafiltration line 104 is in communication with the hemodiafiltration pump 92 such that the filtered dialysate can be pumped through the hemodiafiltration filter 94. The fluid filtered through the hemodiafiltration filter 94 is rinse fluid that can be moved to the reservoir 82 along return line 96.

The rinse clamp 84 can be opened to allow the rinse fluid to move from the reservoir 82 to the T-connector 19 along the rinse line 80. The controller 78 can detect a change in pressure measured at the filter pressure sensor 8 to deactivate blood pump 10 and activate rinse pump 11. Activation of the rinse pump 11 can move the rinse fluid through the dialyzer 3 to remove deposit buildup.

Each of the dialyzing fluid filter 88 and the hemodiafiltration filter 94 can include a semi-permeable membrane. Moving the dialyzing fluid through these two filters to produce rinse fluid reduces the risk that the rinse fluid will contain pyrogens. Thus, the risk of introducing pyrogens into the blood stream can be reduced.

The hemodiafiltration pump 92 is a peristaltic pump that can move fluid at a substantially constant volumetric flow rate. The controller 78 activates the hemodiafiltration pump 92 at substantially the same time that the rinse pump 11 is activated such that the rinse fluid is produced as required to rinse the dialyzer 3. By diverting dialysate fluid to the hemodiafiltration line 104, activation of the hemodiafiltration pump 92 reduces the volumetric flow rate of dialysate through the dialyzer 3 such that the pressure on the dialysate side of the semi-permeable membrane 20 decreases. Because the rinse pump 11 is activated at substantially the same time as the hemodiafiltration pump 92, the addition of the rinse fluid to the arterial line 6 increases the pressure on the blood side of the semi-permeable membrane. Thus, the filtration rate of blood through the dialyzer 3 and the infusion rate of rinse fluid delivered from the hemodiafiltration system 86 balances out such that the hemodiafiltration system 86 can be substantially self-regulating.

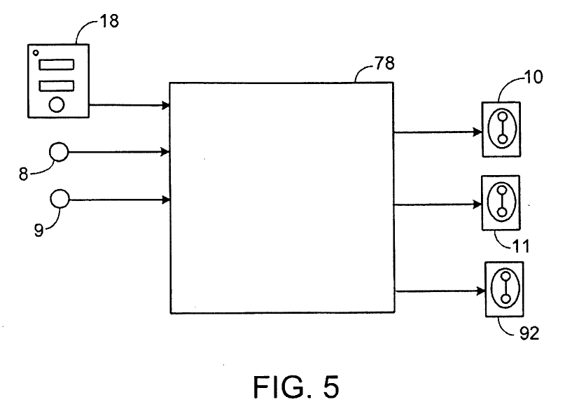

Referring to FIG. 5, the controller 78 is electrically connected to the filter pressure sensor 8, the venous pressure sensor 9, the blood pump 10, the rinse pump 11, and the input device 18. During use, the controller 78 receives input signals from the input device 18, the filter pressure sensor 8, and the venous pressure sensor 9. The controller 78 provides an output signal to the blood pump 10, an output signal to the rinse pump 11 to control the flow of rinse fluid through the dialyzer 3, and an output signal to the hemodiafiltration pump 92 to control the volume of rinse fluid delivered from the hemodiafiltration system 86. The controller 78 controls the activation of the blood pump 10, the rinse pump 11, and the hemodiafiltration pump 92 based on the signals from the filter pressure sensor 8 and the venous pressure sensor 9. Additionally or alternatively, the controller 78 can control the activation of the blood pump 10, the rinse pump 11, and the hemodiafiltration pump 92 based on the signal from the input device 18.

As indicated above, the hemodiafiltration system 86 is substantially self-regulating to provide rinse fluid as required. This can reduce the likelihood of premature shutdowns associated with lack of rinse fluid. Additionally or alternatively, this can reduce the amount of medical staff intervention required when the blood treatment system 74 operates for long periods of time.

While the blood pump 10, the rinse pump 11, and the hemodiafiltration pump 92 have been described as peristaltic pumps, other implementations are possible. For example, in some implementations, the blood pump, the rinse pump, and the hemodiafiltration pump are another type of positive displacement pump such as a diaphragm pump or a flexible impeller pump.

While the blood pump 10 has been described as being stopped prior to activating the rinse pump 11 to pump rinse fluid through the dialyzer 3, in certain implementations, the blood pump 10 is not stopped. In such implementations, blood and rinse fluid can be pumped through the dialyzer 3 at the same time.

While the blood treatment systems described above include a user interface with a display 21 and an input device 18, the blood treatment systems can alternatively include a touch screen that functions as both the display and the input device.

While the blood treatment system I has been described as being used in hemodialysis, the blood treatment system I can be used in other medical procedures that require the use of an extracorporeal circuit to filter blood to remove toxic substances and/or waste. For example, the blood treatment system can be used during medical procedures such as hemoperfusion and plasmapheresis.

1. A blood treatment system, comprising:
a first fluid line capable of being placed in fluid communication with blood of a patient;
a blood filter in fluid communication with the first fluid line;
a blood pump arranged to move blood through at least a portion of the first fluid line and the blood filter when the first fluid line is in fluid communication with the blood of the patient;
a rinse pump arranged to move rinse fluid through the blood filter;
a first pressure sensor arranged to measure pressure of fluid flowing through a portion of the first fluid line between the blood pump and the blood filter; and
a controller in communication with the first pressure sensor and the rinse pump, wherein the controller is configured to activate the rinse pump to move rinse fluid through the blood filter based solely on the pressure of blood flowing through the first fluid line as measured by the first pressure sensor.

2. The blood treatment system of claim 1, wherein the controller is in communication with the blood pump and is configured to deactivate the blood pump based solely on the pressure of blood flowing through the first fluid line as measured by the first pressure sensor.

3. The blood treatment system of claim 1, wherein the rinse pump is in fluid communication with a second fluid line, the second fluid line is in communication with the first fluid line, and the rinse pump is arranged to move rinse fluid through the second fluid line to the first fluid line.

4. The blood treatment system of claim 3, wherein the second fluid line is in fluid communication with a receptacle containing rinse fluid, and the rinse pump is arranged to move rinse fluid from the receptacle into the second fluid line.

5. The blood treatment system of claim 1, wherein the controller is configured to deactivate the rinse pump after a period of operation of the rinse pump.

6. The blood treatment system of claim 5, wherein the controller is configured to activate the blood pump after the period of operation of the rinse pump.

7. The blood treatment system of claim 1, wherein the controller is configured to deactivate the rinse pump based at least in part on the pressure of rinse fluid moving through the first fluid line as measured by the first, pressure sensor.

8. The blood treatment system of claim 7, wherein the controller is configured to activate the blood pump based at least in part on the pressure of the rinse fluid moving through the first fluid line as measured by the first pressure sensor.

9. The blood treatment system of claim 1, further comprising a second pressure sensor arranged to measure pressure of fluid flowing downstream of the blood filter.

10-13. (canceled)

14. The blood treatment system of claim 1, wherein the controller is configured to activate the rinse pump to move rinse fluid through the blood filter when the pressure of the blood measured by the first pressure sensor exceeds a target value by about five percent of the target value or more.

15. The blood treatment system of claim 14, wherein the controller is configured to deactivate the blood pump when the pressure of the blood measured by the first pressure-sensor exceeds the target value by about five percent of the target value or more.

16. The blood treatment system of claim 1, wherein the controller is configured to activate the rinse pump to move rinse fluid through the blood filter when the pressure of the blood measured by the first pressure sensor is above a limit for at least five seconds.

17. The blood treatment system of claim 16, wherein the controller is configured to deactivate the blood pump when the pressure of the blood measured by the first pressure sensor is above the limit for at least five seconds.

18. The blood treatment system of claim 1, wherein the controller is configured to determine a flow rate of the rinse fluid.

19. The blood treatment system of claim 18, wherein the controller is configured to determine the flow rate of the rinse fluid based on a pump speed of the rinse pump.

20. The blood treatment system of claim 18, wherein the controller is configured to set an ultrafiltration rate based on the determined flow rate of the rinse fluid.

21. The blood treatment system of claim 18, wherein the controller is configured to increase an ultrafiltration rate by an amount that is approximately equal to the determined flow rate of the rinse fluid.

22. The blood treatment system of claim 1, further comprising a hemodiafiltration filter in fluid communication with the blood filter, the hemodiafiltration filter being capable of converting dialysis fluid into rinse fluid.

23. The blood treatment system of claim 1, wherein the blood filter is a dialyzer.

24. The blood treatment system of claim 1, wherein the blood treatment system is a hemodialysis system.

25. A blood treatment method, comprising:
moving blood through a blood filter and through a portion of a fluid line positioned between the blood filter and a blood pump;
sensing a first pressure of blood in the fluid line between the blood filter and the blood pump; and
moving rinse fluid through the blood filter based at least in part on the sensed first pressure.

26. The blood treatment method of claim 25, further comprising stopping movement of blood through the blood filter based at least in part on the sensed first pressure of the blood.

27. The blood treatment method of claim 25, further comprising sensing a second pressure of blood flowing downstream of the blood filter.

28. The blood treatment method of claim 27, wherein the rinse fluid is moved through the blood filter based on the sensed first and second pressures.

29. The blood treatment method of claim 28, wherein the rinse fluid is moved through the blood filter if the difference between the sensed first pressure and the sensed second pressure is above a limit.

30. The blood treatment method of claim 29, further comprising stopping movement of blood through the blood filter if the difference between the sensed first pressure and the sensed second pressure is above the limit.

31. The blood treatment method of claim 25, further comprising stopping movement of rinse fluid through the blood filter after a period of time.

32. The blood treatment method of claim 31, further comprising moving blood through the blood filter after the period of time.

33. The blood treatment method of claim 25, further comprising sensing the pressure of rinse fluid in the fluid line between the blood filter and the blood pump, and stopping movement of rinse fluid through the blood filter based at least in part on the sensed pressure of the rinse fluid.

34. The blood treatment method of claim 33, further comprising moving blood through the blood filter based at least in part on the sensed pressure of the rinse fluid.

35. The blood treatment method of claim 25, further comprising deactivating the rinse pump upon determining that a volume of rinse fluid moved through the blood filter is greater than or equal to a threshold volume.

36. The blood treatment method of claim 35, wherein the threshold volume is about 50 mL to about 500 mL.

37. The blood treatment method of claim 25, further comprising determining a flow rate of the rinse fluid.

38. The blood treatment method of claim 37, further comprising performing ultrafiltration at an ultrafiltration rate based on the determined flow rate of the rinse fluid.

39. The blood treatment method of claim 25, further comprising converting dialysis fluid into rinse fluid.

40. The blood treatment method of claim 25, wherein the blood treatment method is a hemodialysis method.

41. The blood treatment system of claim 1, wherein the controller is configured to cause the blood to move at a substantially constant volumetric flow rate through the first fluid line.

42. The blood treatment system of claim 1, wherein the controller is configured to activate an alarm if, after rinse fluid has been passed through the blood filter for a period of time, the pressure measured by the first pressure sensor has not dropped below a given pressure.
